(19) United States
(12) Patent Application Publication
(10) Pub. No.: US 2007/0032575 A1
(43) Pub. Date: Feb. 8, 2007

(54) Syntactic foam

(75) Inventors: John W. Bulluck, Spicewood, TX (US); Brad A. Rix, Spicewood, TX (US); Peyton W. Hall, Del Mar, CA (US)

Correspondence Address: O'KEEFE, EGAN & PETERMAN, L.L.P., Building C, Suite 200, 1101 Capital of Texas Highway South, Austin, TX, 78746, US

(73) Assignee: Texas Research International, Inc.

(21) Appl. No.: 11/199,494

(22) Filed: Aug. 8, 2005

(51) Int. Cl. C08J 9/32

(52) U.S. Cl. 523/219

(57) ABSTRACT

Syntactic foam, comprising a cured product obtained from a composition which comprises: at least one epoxy resin, a curing agent, and hollow microspheres, wherein the microspheres have a density less than 0.25 g/cc and wherein the cured syntactic epoxy foam has a density less than 0.7 g/cc. The foam may be used to repair composites in aircraft.

### BACKGROUND OF INVENTION

This invention pertains to a syntactic epoxy foam which contains glass microspheres.

Although honeycomb core repairs have historically been performed using syntactic foam, the size of the repair has been limited because of the exotherm associated with room temperature curing epoxies. The present inventors have recognized that a need exists for a syntactic foam which has a low exotherm that provides for large repairs.

### SUMMARY OF INVENTION

The present invention provides a solution to one or more of the disadvantages and deficiencies described above.

This invention relates to room-temperature curing, extremely lightweight syntactic epoxy foams that exhibit a high moduli, a high service temperatures, a low exotherm, and good chemical resistance. Both high- and low-molecular weight epoxies in combination with large- and/or small-molecule amines and hollow, glass microspheres create these fast-curing foams that exhibit good adhesion to aluminum, phenolic, and rigid foam substrates. These syntactic foams are useful as repair fillers for lightweight structures such as those constructed from aluminum or Nomex honeycomb, found widely in the aerospace industry, or other composite materials found in the automobile and boating industries. This invention permits core repairs as large as 12 inch diameters and 2.5 inches in thickness to be conducted at room temperature with surface exotherm temperatures less than 100 degrees Centigrade. In large scale repair testing of aluminum and Nomex panels it was determined that the strength of the repair exceeded the panel strength in flexure. The foams of this invention exhibit a very high strength to density ratio. Advantageously, the syntactic foams of this invention allow for large repairs of honeycomb and composites using room temperature curing which provides high strength to density. The syntactic foams exhibited a wide range of reactivities and cured properties.

This invention is, in one broad respect, a syntactic foam, comprising a cured product obtained from a composition which comprises: at least one epoxy resin, a curing agent, and hollow microspheres, wherein the microspheres have a density less than 0.25 g/cc and wherein the cured syntactic epoxy foam has a density less than 0.7 g/cc.

In another broad respect, this invention is a method of repairing a composite having a hole, comprising: applying an uncured syntactic epoxy foam composition to the hole and curing the uncured syntactic epoxy foam composition to form a cured syntactic epoxy foam, wherein the uncured syntactic epoxy foam composition comprises at least one epoxy resin, a curing agent, and hollow microspheres.

In another broad respect, this invention is a method of forming a syntactic foam, comprising: combining at least one epoxy resin, a curing agent, and hollow microspheres to form an uncured syntactic epoxy foam composition, and curing the uncured syntactic epoxy foam composition to form a cured syntactic epoxy foam.

The foam, the method of making the foam, and the method of repairing using the foam can be practiced using one, or a combination of two or more, of the following conditions: wherein the microspheres are glass microspheres; wherein the microspheres have a density of about 0.15 g/cc; wherein the uncured foam further comprises an accelerator; wherein the curing agent is an amine; optionally with 1-3% of fumed silica; wherein the uncured syntactic epoxy foam comprises from about 5 to about 25 percent by weight of the microspheres, in one embodiment from about 5 to about 15 percent by weight, in another embodiment from about 10 to about 15 percent by weight; wherein the uncured syntactic epoxy foam comprises from about 40 to about 75 percent by weight of the epoxy resin, in one embodiment from about 45 to about 65 percent by weight; wherein the epoxy resin is a mixture of a difunctional epoxy resin and a multifunctional epoxy resin, in one embodiment wherein the amount of the difunctional epoxy resin comprises from about 35-60 percent by weight, in one embodiment wherein the multifunctional epoxy resin comprises from about 1 to about 15 percent by weight; wherein the uncured syntactic epoxy foam produces a surface exotherm of less than 100 degrees Centigrade while curing; wherein the syntactic foam of claim 1 further comprising silica, aluminum, or combination thereof; wherein the curing agent is a primary amine, a secondary amine, a tertiary amine, a polyoxyalkylene polyamine or a mixture thereof; wherein the uncured syntactic epoxy foam composition comprises as the at least one epoxy resin (a) a difunctional epoxy resin and (b) a trifunctional epoxy resin or a tetrafunctional epoxy resin; wherein the uncured epoxy foam composition further comprises a thixotrope; wherein the uncured epoxy foam composition further comprises clay particles; wherein the curing occurs at ambient pressure; wherein the composite forms at least a portion of an airplane; wherein the composite is a carbon fiber composite; wherein the uncured syntactic epoxy foam is prepared by mixing a resin side containing epoxy resin and a curative side containing the curing agent; wherein the microspheres are glass microspheres, phenolic microspheres, elastomeric microspheres, or a combination thereof; wherein the microspheres have a density less than 0.25 g/cc and wherein the cured syntactic epoxy foam has a density less than 0.7 g/cc; wherein the uncured syntactic epoxy foam comprises from about 5 to about 25 percent by weight of the microspheres; wherein the uncured syntactic epoxy foam produces a surface exotherm of less than 100 degrees Centigrade while curing and can provide a tack free time of no greater than 2 hours; and any combination of these embodiments.

Advantageously, the syntactic foam of this invention has a low exotherm during cure, and can be used to make repairs of, for example, aircraft made from composite materials.

### DETAILED DESCRIPTION OF THE INVENTION

The syntactic foam of this invention is in one broad respect formed from at least one epoxy resin, a curing agent, optionally an accelerator, and density reducing microspheres.

### Epoxy Resins

The epoxy resin used in the practice of this invention may vary and includes conventional, commercially available epoxy resins. Two or more epoxy resins may be employed in combination. In general, the epoxy resins can be glycidated resins, cycloaliphatic resins, epoxidized oils, and so forth. The glycidated resins are frequently the reaction product of a glycidyl ether, such as epichlorohydrin, and a bisphenol compound such as bisphenol A. C₄-C₂₈ alkyl glycidyl ethers; C₂-C₂₈ alkyl-and alkenyl-glycidyl esters; C₁-C₂₈ alkyl-, mono- and poly-phenol glycidyl ethers; polyglycidyl ethers of pyrocatechol, resorcinol, hydroquinone, 4,4′-dihydroxydiphenyl methane (or bisphenol F), 4,4′-dihydroxy-3,3′-dimethyldiphenyl methane, 4,4′-dihydroxydiphenyl dimethyl methane (or bisphenol A), 4,4′-dihydroxydiphenyl methyl methane, 4,4′-dihydroxydiphenyl cyclohexane, 4,4′-dihydroxy-3,3′-dimethyldiphenyl propane, 4,4′-dihydroxydiphenyl sulfone, and tris (4-hydroxyphynyl)methane; polyglycidyl ethers of the chlorination and bromination products of the above-mentioned diphenols; polyglycidyl ethers of novolacs; polyglycidyl ethers of diphenols obtained by esterifying ethers of diphenols obtained by esterifying salts of an aromatic hydrocarboxylic acid with a dihaloalkane or dihalogen dialkyl ether; polyglycidyl ethers of polyphenols obtained by condensing phenols and long-chain halogen paraffins containing at least two halogen atoms; N,N′-diglycidyl-aniline; N,N′-dimethyl-N,N′-diglycidyl-4,4′-diaminodiphenyl methane; N,N,N′,N′-tetraglycidyl-4,4′-diaminodiphenyl methane; N,N′-diglycidyl-4-aminophenyl glycidyl ether; N,N,N′,N′-tetraglycidyl-1,3-propylene bis-4-aminobenzoate; phenol novolac epoxy resin; cresol novolac epoxy resin; and combinations thereof. Representative non-limiting examples of epoxy resins useful in this invention include bis-4,4′-(1-methylethylidene) phenol diglycidyl ether and (chloromethyl) oxirane Bisphenol A diglycidyl ether. Commercially available epoxy resins that can be used in the practice of this invention include but are not limited to Araldyte GY6010 and Epon 828. ?? Typically, the epoxy resin has a viscosity of from about 1000 to about 14,000.

One particular commercial epoxy resin that has been found to be advantageous is PY313 US from Vantico. This epoxy resin provided syntactic foams with good physical properties, including shear strengths of about 600 pounds per square inch (“psi”), tensile strengths of about 1200 psi, and hardness up to 75 Shore D. The PY313 US resin, which is a modified bisphenol A resin blend, has low viscosity (1000 centipoise) that enables a large amount of glass microspheres to be incorporated into it. The epoxy resin has a shear modulus of 50-108 ks.

The final foam has compression strengths of 1300 to 2500 psi and compressive moduli of 77-115 ksi.

In one embodiment, the uncured syntactic epoxy foam composition comprises as the at least one epoxy resin (a) a difunctional epoxy resin and (b) a multifunctional epoxy resin such as a trifunctional epoxy resin or a tetrafunctional epoxy resin.

In general, the epoxy resin, or mixture of resins, is employed in an amount such that the uncured syntactic epoxy foam comprises from about 40 to about 75 percent by weight of the epoxy resin, and in one embodiment from about 45 to about 65 percent by weight. In one embodiment, the epoxy resin is a mixture of a difunctional epoxy resin and a multifunctional epoxy resin, in one embodiment wherein the amount of the difunctional epoxy resin comprises from about 35 to about 60 percent by weight, in one embodiment wherein the multifunctional epoxy resin comprises from about 1 to about 15 percent by weight.

### Curing Agents and Accelerators

A variety of curing agents will be used in the syntactic foams of this invention. The selection of a given curing agent is dependent on the size of the syntactic foam batch to be cured and the reactivity of a given curing agent. Depending on the reactivity of the given curing agent and size of a batch, it may be desirable to include an accelerator to improve curing. In general, the curatives of this invention combine sufficiently low exotherms with acceptable cure times, typically around one hour. Selection of suitable curing agents, optionally including an accelerator, can be performed by testing a given curing agent with a sample batch of the syntactic foam starting materials, and measuring the exotherm and cure time.

An amine curing agent is employed in the practice of this invention. Various polyamines can be used for this purpose, including aliphatic and aromatic amines, cycloaliphatic amines, a Lewis base or a Mannich base. For example, the aliphatic amine and cycloaliphatic amines may be alkylene diamines such as ethylene diamine, propylene diamine, 1,4-diaminobutane, 1,3-diaminopentane, 1,6-diaminohexane, 2,5-diamino-2,5-dimethylhexane, 2,2,4-trimethyl-1,6-diaminohexane, 1,11-diaminoundecane, 1,12-diaminododecane, 1,3- or 1,4-cyclohexame diamine, 1-amino-3,3,5-trimethyl-5-aminomethyl-cyclohexane, 2,4- or 2,6-hexahydrotolvylene diamine 2,4′- or 4,4′-diaminodicyclohexyl methane, 3,3′-dialkyl-4,4′-diamino-dicyclohexyl methane isophoronediamine, trimethylhexamethylene diamine, triethylene diamine, piperazine-n-ethylamine, polyoxyalkylene diamines made from propylene oxide and/or ethylene oxide. Commercially available amine curing agents may sometimes include residual amounts of solvents such as benzyl alcohol used in the manufacture of the compounds. The aromatic polyamines may include 2,4- or 2,6-diaminotoluene and 2,4′- or 4,4′-diaminodiphenyl methane. Mixtures of amine curing agents may be employed.

A representative commercially available example of such curing agents is Ancamine 2089M. Ancamine 2089M is a modified, aliphatic amine. This curative is highly reactive and is not appropriate for large repairs because the exotherm is excessive (>200° C. for a 100 g sample). However, for a small repair, the Ancamine 2089M will provide a quick cure with a lower exotherm.

In one embodiment, the curing agent is a primary amine, a secondary amine, a tertiary amine, a polyoxyalkylene polyamine or a mixture thereof.

Another class of curing agents that can be employed in the practice of this invention is polyoxyalkylene polyamines. Representative examples of such polyoxyalkylene polyamines include JEFFAMINE D230 and JEFFAMINE D2000, which are both polyoxypropylene diamines of different molecular weights. Depending on the level and type of accelerator in the system, these systems typically have a low exotherm and longer cure times (up to 4 hours). These characteristics make the foam formulated with these curatives suitable for large repairs (1 gallon).

Another class of curing agent is a phenalkamine curative. A representative example of a commercially available phenalkamine is Aradur 3442 from Vantico, which is a polyamine derived from cashew nutshell liquid. Due to its reactivity, it is believed that Aradur 3442 would be best suited for medium-sized and large-sized batches (e.g. a quart volume or larger such as up to a gallon).

The amount of amine curing agent, or mixture of curing agents, may vary depending on the amount of epoxy resin to be cured. In general, the amount of amine curing agent employed is so that the volumetric ratio of an amine side to an epoxy side is from about 30:70 to about 70:30, with a weight ratio of from about 1:15 to 15:1 being most typical. Typically, the mole ratio of amine curing agent to the epoxy resin is in the range from about 0.25 to about 2.5, and in one embodiment is about 1:1.

### Accelerators

With the exception the highly reactive curatives for small batches, such as the Ancamine 2089M type curative for which no accelerator is needed, an accelerator can optionally be used in the practice of this invention in combination with the curative. One representative example of such a commercially-available accelerator is Huntsman Chemical's 399. Accelerator 399 is a mixture of primary, secondary, and tertiary amines that can produce a quick gel time with an exotherm <100° C. if used in proper amounts. The amount of accelerator employed may vary depending on the particular curative employed and reactivity of the epoxy resin. In general, the accelerator is used in an amount of from about 5 to about 15 percent based on the weight of the mixed formulation. In one embodiment, the accelerator is used in an amount of from about 2 to about 9 percent based on the weight of.

### Density-Reducing Microspheres

Hollow inorganic microspheres are employed in the syntactic foam of this invention, and function to reduce the density of the foam. A representative example of such microspheres includes glass microspheres. Representative examples of commercially available glass microspheres include S15/300, B38, C15, K20, VS 5500, A16, H2O and the like, which are available from 3 M. These microspheres have a very low density (for example, about 0.15 g/cc) and are capable of reducing the overall density of the syntactic foams to less than 0.7 g/cc. Physical test results of foams constructed of both the untreated and surface-treated microspheres have shown that the untreated microspheres (S15/300) lend much better physical properties in terms of shear and tensile strengths. Representative formulations include those using mixture of treated H2O microspheres and treated A16 microspheres, and a mixture of treated H2O microspheres and untreated S15 microspheres.

In general, the microspheres have diameters in the range from about 1 to about 500 micrometers, and in one embodiment from about 5 to about 200 micrometers. In one embodiment, the microspheres have a wall thickness in the range from about 0.1 micrometer to about 20 micrometers. In one embodiment the microspheres have a density of wherein the microspheres have a density of about 0.05 to about 0.25 g/cc, in another embodiment of from about 0.1 to about 0.2 g/cc, and in one embodiment a density of about 0.15 g/cc.

The microspheres are generally employed in an amount in the uncured syntactic epoxy foam comprises from about 5 to about 25 percent by weight of the microspheres, in one embodiment from about 5 to about 15 percent by weight, and in another embodiment from about 10 to about 15 percent by weight.

### Additives

A variety of additives can optionally be included in the syntactic foam of this invention. For example, one or more corrosion inhibitors may be included. These serve to reduce the amount of corrosion of a metal substrate at the primer/surface interface. A wide variety of such corrosion inhibitors may be used. Representative examples of such corrosion inhibitors include zinc-based inhibitors such as zinc phosphate, zinc-5-nitro-isophthalate, zinc molybdate, and zinc oxide and hydrophobic, moisture penetration inhibitors such as hydrophobic, amorphous fumed silica. These may be used in any amount effective to provide corrosion inhibition. In one embodiment, the corrosion inhibitor, or mixture of inhibitors, can be employed in an amount of from about 0.1 to about 10 percent of the foam. Similarly, a UV light stabilizer may be included. This serves to protect the cured coating from the harmful effects of UV light. Representative examples of such stabilizers include sterically hindered piperidine derivatives including an alkyl substituted hydroxy piperidines such as dimethyl sebacate, methyl-1,2,2,6,6-pentamethyl-4-piperidinyl sebacate, bis (1,2,2,6,6-pentamethyl-4-piperidinyl) sebacate, and 1,2,2,6,6-pentamethyl-4-piperidinol. This may be used in any amount effective to provide UV stabilization. In one embodiment, the stabilizer can be employed in an amount of from about 0.1 to about 10 percent of the foam. The coating can include one or more pigments to provide any desired color. The pigments can vary, depending on the desired color of the final coating. For example, if a gray coating is desired, white and black pigments can be used. If a yellow coating is desired, then yellow pigments can be employed, and so on. A representative example of a darkening pigment is black iron oxide. Black iron oxide also has the desirable property of being infrared transparent and thus may serve as an IR transparent darkening agent. This is beneficial because infrared absorption by the coating causes the surface temperature to rise, which is undesirable. Likewise, an IR reflector may be included in the coatings of this invention. One such IR reflector is titanium dioxide, which may also serve as a pigment. By reflecting IR light, the coating is less prone to becoming heated in sunlight. In one embodiment, the pigment can be employed in an amount of from about 0.1 to about 10 percent of the foam. Various fire retardants may be used in the practice of this invention. Common fire retardants include an alumina such as alumina trihydrate, magnesium hydroxide, bismuth oxide, zinc borate, potassium tripolyphosphate, and antimony oxide. Combinations of these fire retardants can be employed, such as magnesium hydroxide with alumna trihydrate, and zinc borate with magnesium hydroxide and/or alumna trihydrate. Fire retardants that are not known carcinogens are preferred in the practice of this invention. In general, the fire retardants may be employed in an amount of from about 5 to about 40 percent by weight based on the total weight of a given formulation.

The syntactic foam can also include one or more toughening agents. A toughening agent functions to improve impact resistance. The toughening agent may be selected from conventional toughening agents such as rubber toughening agents and an epoxide-containing toughening agent such as an aliphatic triglycidyl ether, a polyepoxide, aliphatic monoglycidyl ether, aliphatic epoxy resin toughening agents, and combinations thereof. If used, the toughening agent can be employed in an amount of from about 0.1 to about 10 percent of the foam. Representative examples of rubber tougheners include amine-terminated butadiene nitrile (ATBN) and carboxy-terminated butadiene nitrile (CTBN). Apart from the microspheres, other fillers can be used in the syntactic foam, such as conventional organic or inorganic fillers such as silica, calcium carbonate, fibers (e.g., glass or carbon fibers), calcium oxide, talc, clays, metals, carbon, wollastonite, feldspar, aluminum silicate, ceramics, and the like. The additional filler, if present, can be in an amount up to about 10 percent of the cured syntactic foam composition.

In the preparation of the syntactic foam, the various additives can be added to either the epoxy side or the curing agent side or both.

### Physical Properties

The cured syntactic foam of this invention, advantageously, has a density in the range from about 0.5 to about 0.7 g/cc. In one embodiment, the foam has a density in the range from about 0.55 to about 0.65 g/cc. The syntactic foam of this invention advantageously provides a surface exotherm during cure that typically does not exceed 100 degrees Centigrade. The syntactic foam of this invention has additional desirable properties. Tack free times range from 15 minutes to two hours, depending on the type of foam used and the shape and size of the repair. Shear strengths of about 400-800 psi, including about 600psi are typically obtained. Compressive strengths of the final foam are typically in the range from 1500-2200 psi. Tensile strengths of the foam typically range from 700-1200 psi. The foams have good resistance to fuels and excellent resistance to hydraulic fluids and oils.

### Excluded Material

In the practice of this invention, the syntactic foams can be prepared in the absence of materials such as aramid fibers, blowing agents (chemical blowing agents such as azodicarbonamide and sulfonyl hydrazide), non-reactive organic solvents, individually or any combination thereof. By non-reactive organic solvent it is meant liquids (at room temperature) which do not react with the epoxy resin, curing agents, or accelerators, and which is intended to be evaporated from the syntactic foam before or after curing is complete.

The following examples are illustrative of this invention and are not intended to be limiting as to the scope of the invention or claims hereto. Unless otherwise denoted all percentages are by weight of the total part.

Formulations were combined and mixed according to the compositions shown in the following tables.

EXAMPLE 1

| Components | Grams |
|---|---|
| Huntsman PY313US | 100 |
| Accelerator 399 | 14 |
| 3M Scotchlite Glass Bubbles D32/4500 | 37 |
| Jeffamine D230 | 22 |

EXAMPLE 2

| Components | Grams |
|---|---|
| Huntsman PY313US | 100 |
| Accelerator 399 | 14 |
| 3M Scotchlite Glass Bubbles D32/4500 | 54 |
| Jeffamine D230 | 22 |

EXAMPLE 3

| Components | Grams |
|---|---|
| Huntsman GY6010 | 100 |
| 3M Scotchlite Glass Bubbles D32/4500 | 55 |
| Ancamine 2089 | 40 |

EXAMPLE 4

| Components | Grams |
|---|---|
| Huntsmna GY6010 | 100 |
| 3M Scotchlite Glass Bubbles D32/4500 | 42.5 |
| Euredur 14 | 40 |

Formulations were tested for their shear modulus values. Overall many of the foams developed exhibited a shear modulus greater than 40 ksi. Below are the results of the testing.

| Formulation | Shear Modulus (ksi) |
|---|---|
| Example 1 | 53.5 |
| Example 2 | 89.0 |
| Example 3 | 76.1 |
| Example 4 | 60.9 |
| Ciba-Geigy Foam Epocast 1632 | 32.4 |

Formulations were tested to compare the theoretical density of the syntactic foam with the empirically derived value. Below are the results of the study. There is good correlation between the observed density and the theoretical density. The disparity between the two values can be attributed to the air entrainment in the test samples.

Formulations were prepared according to the formula in the following table:

| | | |
|---|---|---|
| Densities | Huntsman PY313US | 1.0913 |
| | Epoxy | |
| | 3M D32-4520 Spheres | 0.32 |
| | Euredur 14 Hardener | 1 |
| | Nonyl Phenol | 0.94 |

The formulation listed immediately above was used to mix formulations containing these components, with only the amount of microspheres being varied. The resulting syntactic foams were subjected to testing, as shown in Table 17.

TABLE 17
Density of Selected Syntactic Foam Raw Materials

| | Glass | Vol of | | | | | | | Volume |
|---|---|---|---|---|---|---|---|---|---|
| | Micro- | micro- | Volume | | | | | Void | Percent |
| Form | spheres | spheres | of resin | Total | Calculated | Measured | | content | Micro- |
| # | by Wt | cc's | cc's | Volume | Density | Density | Delta | (vol %) | spheres |
| 1 | 37 | 116 | 92 | 207 | 0.73 | 0.64 | 0.09 | 12.2 | 44.2 |
| 2 | 20 | 63 | 92 | 154 | 0.83 | 0.73 | 0.10 | 12.5 | 59.5 |
| 3 | 20 | 63 | 92 | 154 | 0.83 | 0.78 | 0.05 | 6.5 | 59.5 |
| 4 | 54 | 169 | 92 | 260 | 0.65 | 0.54 | 0.11 | 16.7 | 35.2 |
| 5 | 20 | 63 | 92 | 154 | 0.83 | 0.89 | −0.06 | −6.9 | 59.5 |
| 6 | 54 | 169 | 92 | 260 | 0.65 | 0.58 | 0.07 | 11.3 | 35.2 |
| 7 | 54 | 169 | 92 | 260 | 0.65 | 0.56 | 0.09 | 13.9 | 35.2 |
| 8 | 20 | 63 | 92 | 154 | 0.83 | 0.81 | 0.02 | 2.7 | 59.5 |
| 9 | 37 | 116 | 92 | 207 | 0.73 | 0.58 | 0.15 | 20.5 | 44.2 |
| 10 | 37 | 116 | 92 | 207 | 0.73 | 0.67 | 0.06 | 7.9 | 44.2 |
| 11 | 20 | 63 | 92 | 154 | 0.83 | 0.75 | 0.08 | 9.4 | 59.5 |
| 12 | 54 | 169 | 92 | 260 | 0.65 | 0.55 | 0.10 | 15.9 | 35.2 |
| 1a | 55 | 172 | 92 | 264 | 0.65 | 0.60 | 0.04 | 6.7 | 34.8 |
| 2a | 42.5 | 133 | 92 | 224 | 0.70 | 0.68 | 0.02 | 3.0 | 40.8 |
| 3a | 55 | 172 | 92 | 264 | 0.65 | 0.58 | 0.07 | 10.6 | 34.8 |
| 4a | 42.5 | 133 | 92 | 224 | 0.70 | 0.67 | 0.03 | 4.3 | 40.8 |
| 5a | 30 | 94 | 92 | 185 | 0.77 | 0.72 | 0.05 | 6.6 | 49.4 |
| 6a | 30 | 94 | 92 | 185 | 0.77 | 0.72 | 0.05 | 6.0 | 49.4 |

In general, the measured density was less than the calculated density.

Further modifications and alternative embodiments of this invention will be apparent to those skilled in the art in view of this description. Accordingly, this description is to be construed as illustrative only and is for the purpose of teaching those skilled in the art the manner of carrying out the invention. It is to be understood that the forms of the invention herein shown and described are to be taken as illustrative embodiments. Equivalent elements or materials may be substituted for those illustrated and described herein, and certain features of the invention may be utilized independently of the use of other features, all as would be apparent to one skilled in the art after having the benefit of this description of the invention.

What is claimed is:

1. Syntactic foam, comprising a cured product obtained from a composition which comprises: at least one epoxy resin, a curing agent, and hollow microspheres, wherein the microspheres have a density less than 0.25 g/cc and wherein the cured syntactic epoxy foam has a density less than 0.7 g/cc.

2. The syntactic foam of claim 1 wherein the microspheres are glass microspheres.

3. The syntactic foam of claim 1 wherein the microspheres have a density of about 0.15 g/cc.

4. The syntactic foam of claim 1 further comprising an accelerator.

5. The syntactic foam of claim 1 wherein the curing agent is an amine.

6. The syntactic foam of claim 1 wherein the uncured syntactic epoxy foam comprises from about 5 to about 25 percent by weight of the microspheres.

7. The syntactic foam of claim 1 wherein the uncured syntactic epoxy foam comprises from about 40 to about 75 percent by weight of the epoxy resin.

8. The syntactic foam of claim 1 wherein the epoxy resin is a mixture of a difunctional epoxy resin and a multifunctional epoxy resin, in one embodiment wherein the amount of the difunctional epoxy resin comprises from about 35 to about 60 percent by weight.

9. The syntactic foam of claim 1 wherein the uncured syntactic epoxy foam produces a surface exotherm of less than 100 degrees Centigrade while curing.

10. The syntactic foam of claim 1 further comprising silica, aluminum, or combination thereof.

11. The syntactic foam of claim 1 wherein the curing agent is a primary amine, a secondary amine, a tertiary amine, a polyoxyalkylene polyamine or a mixture thereof.

12. The syntactic foam of claim 1 wherein the uncured syntactic epoxy foam composition comprises as the at least one epoxy resin (a) a difunctional epoxy resin and (b) a trifunctional epoxy resin or a tetrafunctional epoxy resin.

13. The syntactic foam of claim 1 wherein the uncured epoxy foam composition further comprises a thixotrope to aid in mixing by providing shear thinning.

14. The syntactic foam of claim 1 wherein the uncured epoxy foam composition further comprises clay particles, wherein the amount of clay particles is an amount in the range of 1 to 4 based on the total weight of the uncured syntactic epoxy foam composition.

15. A method of repairing a composite having a hole, comprising: applying an uncured syntactic epoxy foam composition to the hole and curing the uncured syntactic epoxy foam composition to form a cured syntactic epoxy foam, wherein the uncured syntactic epoxy foam composition comprises at least one epoxy resin, a curing agent, and hollow microspheres.

16. The method of claim 15 wherein the curing occurs at ambient pressure.

17. The method of claim 15 wherein the composite forms at least a portion of an airplane.

18. The method of claim 15 wherein the composite is a carbon fiber composite.

19. The method of claim 15 wherein the uncured syntactic epoxy foam is prepared by mixing a resin side containing epoxy resin and a curative side containing the curing agent.

20. The method of claim 15 wherein the microspheres are glass microspheres, phenolic microspheres, elastomeric microspheres, or a combination thereof.

21. The method of claim 15 wherein the microspheres have a density less than 0.25 g/cc and wherein the cured syntactic epoxy foam has a density less than 0.7 g/cc.

22. The method of claim 15 wherein the microspheres are glass microspheres.

23. The method of claim 15 wherein the microspheres have a density of about 0.15 g/cc.

24. The method of claim 15 wherein the uncured epoxy foam further comprises an accelerator.

25. The method of claim 15 wherein the curing agent is an amine.

26. The method of claim 15 wherein the uncured syntactic epoxy foam comprises from about 5 to about 25 percent by weight of the microspheres.

27. The method of claim 15 wherein the uncured syntactic epoxy foam comprises from about 40 to about 75 percent by weight of the epoxy resin.

28. The method of claim 15 wherein the epoxy resin is a mixture of a difunctional epoxy resin and a multifunctional epoxy resin, wherein the difunctional epoxy resin comprises from about 35 to about 60 percent by weight of the uncured syntactic epoxy foam composition, and wherein the multifunctional epoxy resin comprises from about 1 to about 15 percent by weight of the uncured syntactic epoxy foam composition.

29. The method of claim 15 wherein the uncured syntactic epoxy foam produces a surface exotherm of less than 100 degrees Centigrade while curing.

30. The method of claim 15 wherein the uncured syntactic epoxy foam composition further comprises silica, aluminum, or combination thereof.

31. The method of claim 15 wherein the curing agent is a polyoxyalkylene polyamine, a mixture of primary, secondary, and tertiary amines, or mixtures thereof.

32. The method of claim 15 wherein a solvent is absent in the uncured syntactic epoxy foam composition.

33. The method of claim 15 wherein the uncured epoxy foam composition further comprises a thixotrope.

34. The method of claim 15 wherein the uncured epoxy foam composition further comprises clay particles, wherein the amount of clay particles is an amount in the range of 1 to 4 based on the total weight of the uncured syntactic epoxy foam composition.

35. The method of claim 15 wherein the uncured syntactic epoxy foam composition includes a curing agent, wherein the curing agent is effective to provide an exotherm of the composition during curing that does not exceed 100 degrees Centigrade and can provide a tack free time of no greater than 2 hours.

36. A method of forming a syntactic foam, comprising: combining at least one epoxy resin, a curing agent, and hollow microspheres to form an uncured syntactic epoxy foam composition, and curing the uncured syntactic epoxy foam composition to form a cured syntactic epoxy foam.

37. The method of claim 36 wherein the curing occurs at ambient pressure.

38. The method of claim 36 wherein the uncured syntactic epoxy foam is prepared by mixing a resin side containing epoxy resin and a curative side containing the curing agent.

39. The method of claim 36 wherein the microspheres are glass microspheres, phenolic microspheres, elastomeric microspheres, or mixtures thereof.

40. The method of claim 36 wherein the microspheres have a density less than 0.25 g/cc and wherein the cured syntactic epoxy foam has a density less than 0.7 g/cc.

41. The method of claim 36 wherein the microspheres are glass microspheres having a density of about 0.15 g/cc.

42. The method of claim 36 wherein the uncured composition further comprises an accelerator.

43. The method of claim 36 wherein the curing agent is a polyoxyalkylene polyamine, a mixture of primary, secondary, and tertiary amines, or mixtures thereof.

44. The method of claim 36 wherein the uncured syntactic epoxy foam comprises from about 5 to about 25 percent by weight of the microspheres.

45. The method of claim 36 wherein the uncured syntactic epoxy foam comprises from about 40 to about 75 percent by weight of the epoxy resin.

46. The method of claim 36 wherein the epoxy resin is a mixture of a difunctional epoxy resin and a multifunctional epoxy resin wherein the amount of the difunctional epoxy resin comprises from about 35 to about 60 percent by weight of the uncured syntactic epoxy foam composition wherein the multifunctional epoxy resin comprises from about 1 to about 15 percent by weight of the uncured syntactic epoxy foam composition.

47. The method of claim 36 wherein the uncured syntactic epoxy foam produces a surface exotherm of less than 100 degrees Centigrade while curing.

48. The method of claim 36 wherein the uncured syntactic epoxy foam composition further comprises silica, aluminum, or combination thereof.

49. The method of claim 36 wherein a solvent is absent in the uncured syntactic epoxy foam composition.
